(19) United States
(12) Patent Application Publication
(10) Pub. No.: US 2025/0242978 A1
(43) Pub. Date: Jul. 31, 2025

(54) CONTAINER BOX

(71) Applicant: YAZAKI CORPORATION, Tokyo (JP)

(72) Inventors: Toshinori Yamada, Makinohara-shi (JP); Hirotaka Kiyota, Makinohara-shi (JP)

(21) Appl. No.: 19/183,749

(22) Filed: Apr. 18, 2025

Related U.S. Application Data
(63) Continuation of application No. PCT/JP2024/001486, filed on Jan. 19, 2024.

(30) Foreign Application Priority Data
Feb. 21, 2023 (JP) 2023-024919

(51) Int. Cl. B65D 43/02

(52) U.S. Cl. CPC B65D 43/0222; B65D 2543/00194; B65D 2543/00527; B65D 2543/00537; B65D 2543/00972

(57) ABSTRACT

A container box includes a main body portion, a cover portion, and a packing member. The main body portion has a side wall. The packing member has a packing body, a seal portion protruding from the packing body, and a void portion formed on a side opposite to the side wall with respect to the seal portion and allowing bending of the seal toward an opposite side. The seal portion protrudes obliquely toward a side on which the side wall is located with respect to the attachment direction in a state where the cover portion is not attached to the main body portion, and the seal portion includes a first lip being formed at a distal end of the seal portion and coming in contact with a side surface of the side wall in a state where the cover portion is attached to the main body portion.

### CROSS-REFERENCE TO RELATED APPLICATION(S)

This application is a continuation application of International Application No. PCT/JP2024/001486 filed on Jan. 19, 2024 which claims the benefit of priority from Japanese Patent Application No. 2023-024919 filed on Feb. 21, 2023 and designating the U.S., the entire contents of which are incorporated herein by reference.

### BACKGROUND OF THE INVENTION

### 1. Field of the Invention

The present invention relates to a container box.

### 2. Description of the Related Art

Conventionally, as a container box, for example, as described in JP 2000-115 955 A and JP 2004-019 887 A, there is known a container box including a lid member openable and closable with respect to a housing. In the container box, a packing is disposed at a position on the lid member where the packing abuts on the housing, and this packing functions as a water stop between the housing and the lid member.

When using the above-described container member, there is a situation where efforts to enhance water-stop performance make it difficult to attach the lid member to the housing. That is, when using the above-described container member, it is necessary to firmly press the lid member against the housing in order to obtain high water-stop performance. Because of this, a strong force would be needed in attachment of the lid member to the housing, leading to a failure in achieving smooth operation of attaching the lid member.

To handle this, it is conceivable to perform water stop between the housing and the lid member by bringing a packing attached to the lid member into contact with a side surface of the housing. In this case, since the attachment direction of the lid member differs from the contact direction of the packing, it might be possible to achieve smooth attachment work of the lid member. However, this method also has room for improvement in difficulty to manufacture the packing when using the packing by setting its lip to protrude from the packing to be brought in contact with the side surface of the housing. For example, the lip of the packing is to protrude in an intersecting direction with respect to the attachment direction of the lid member. In this case, the lip will form an undercut in manufacturing the packing by molding, leading to a possibility of making the molding of the packing impractical.

### SUMMARY OF THE INVENTION

In view of this, an object of the present invention is to provide a container box capable of satisfactorily molding a packing member while ensuring a water-stop function by the packing member.

In order to achieve the above mentioned object, a container box according to one aspect of the present invention includes a main body portion that is capable of internally accommodating an accommodation object and has an opening that allows communication between an inside and an outside of the main body portion; a cover portion attached to the main body portion so as to cover the opening; and a packing member provided in the cover portion and configured to perform water stop between the main body portion and the cover portion, wherein the main body portion includes a side wall formed along an attachment direction of the cover portion with respect to the main body portion and surrounding the inside, the packing member forms a packing body attached to the cover portion, a seal portion protruding from the packing body and coming in contact with the side wall, and a void portion formed on an opposite side being a side opposite to the side wall with respect to the seal portion and allowing bending of the seal portion toward the opposite side, and the seal portion protrudes obliquely toward a side on which the side wall is located with respect to the attachment direction of the cover portion and the main body portion side in a state where the cover portion is not attached to the main body portion, and the seal portion includes a first lip being formed at a distal end of the seal portion and coming in contact with a side surface of the side wall in a state where the cover portion is attached to the main body portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exploded perspective view of a container box according to an embodiment;

FIG. 2 is a perspective view of the container box according to the embodiment;

FIG. 3 is a cross-sectional view of the container box taken along line III-III of FIG. 2;

FIG. 4 is a cross-sectional view of the container box when a main body portion and a cover portion are separated from each other;

FIG. 5 is an explanatory view of a packing member in the container box according to the embodiment;

FIG. 6 is an explanatory view of the packing member in the container box according to the embodiment;

FIG. 7 is an explanatory view of moldability of the container box according to the embodiment;

FIG. 8 is an explanatory view of moldability of the container box according to the embodiment;

FIG. 9 is an explanatory view of moldability of the container box according to the embodiment; and

FIG. 10 is an explanatory view of a modification of the container box according to the embodiment.

### DETAILED DESCRIPTION OF THE PREFERRED EMBODIMENTS

Embodiments according to the present invention will be described below in detail with reference to the drawings. Note that the present invention is not limited by the embodiment. Moreover, components in the following embodiment include those easily interchangeable by those skilled in the art or substantially identical.

### Embodiment

The present embodiment relates to a container box. The following description uses a first direction, a second direction, and a third direction intersecting each other, in which the first direction is denoted as a “depth direction X”, the second direction is denoted as a “width direction Y”, and the third direction is denoted as a “attachment direction Z”. The depth direction X, the width direction Y, and the attachment direction Z are orthogonal to each other. The attachment direction Z is an attachment direction of the cover portion with respect to the main body portion, and corresponds to height direction of the main body portion and the cover portion. The depth direction X and the width direction Y correspond to intersecting directions, being directions intersecting the attachment direction Z. Unless otherwise specified, each direction used in the following description will be given as a direction in a state where the individual portions are assembled to each other. The term “orthogonal” as used herein includes substantially orthogonal.

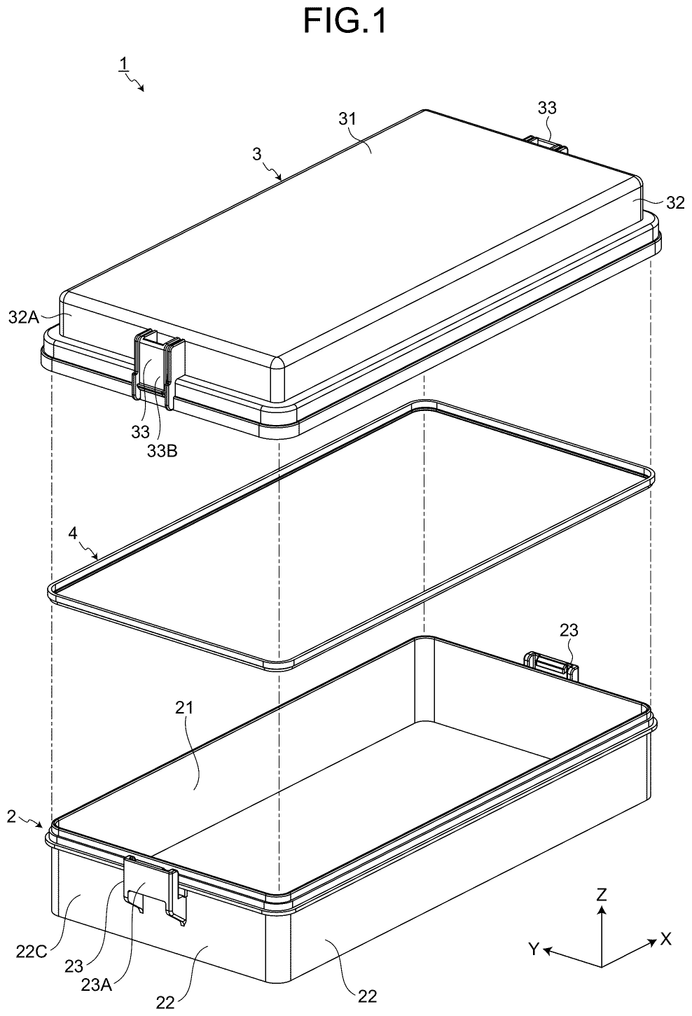

As illustrated in FIG. 1, a container box 1 according to the present embodiment is a box that accommodates an accommodation object, and is used as, for example, an electrical connection box that is mounted on a vehicle and accommodates an electronic component 9 including a fuse and a relay. The container box 1 includes a main body portion 2, a cover portion 3, and a packing member 4. The main body portion 2 is a box member having an open upper surface, and has a rectangular parallelepiped shape, for example. The rectangular parallelepiped herein includes a substantially rectangular parallelepiped. The main body portion 2 is capable of internally accommodating the electronic component 9 as an accommodation object, and has, on its upper surface, an opening 21 that allows communication between the inside and the outside of the main body portion 2. The opening 21 of the main body portion 2 is closed by attachment of the cover portion 3. The opening 21 is formed as an opening that opens the entire upper surface of the main body portion 2, for example. While the main body portion 2 in FIG. 1 has a bottom, it is also allowable to open the bottom and have a lower cover, which is detachably attached to the open bottom.

There is provided a lock-catch unit 23 on a side wall 22 of the main body portion 2. The side wall 22 is a portion constituting a side of the main body portion 2, and is formed in the attachment direction Z of the cover portion 3 to surround the inside of the main body portion 2. For example, the side wall 22 is formed at four positions, the front, rear, left, and right. The inside of the main body portion 2 is an internal space of the main body portion 2, for example, a space surrounded by the side wall 22 or the like. The lock-catch unit 23 is a portion to be locked by a locking unit 33 of the cover portion 3. The lock-catch unit 23 includes a lock-catch piece 23A provided separated from a surface 22C on the outside of the side wall 22. The lock-catch unit 23 is provided at each upper position on the two opposing side walls 22, on one for one location basis.

The cover portion 3 is an upper cover that covers the opening 21 of the main body portion 2, and can be attached to the main body portion 2 so as to cover the opening 21. The cover portion 3 includes a top surface portion 31 and a hanging portion 32. The top surface portion 31 is an upper surface portion of the cover portion 3, and has a shape corresponding to the shape of the main body portion 2, for example, a rectangular shape or a substantially rectangular shape. The hanging portion 32 is a wall portion extending downward from the outer edge of the top surface portion 31, and is formed over an entire circumference of an outer edge of the top surface portion 31. The cover portion 3 has the locking unit 33. The locking unit 33 is a portion that engages with the lock-catch unit 23 of the main body portion 2 to hold and release the cover portion 3 with respect to the main body portion 2. The locking unit 33 is provided, for example, on a surface 32A on the outside of the hanging portion 32, at a position corresponding to the lock-catch unit 23. The locking unit 33 includes a locking arm 33B that is inserted into the lock-catch piece 23A to be locked by the lock-catch piece 23A. The locking unit 33, together with the lock-catch unit 23, constitutes a lock mechanism. This lock mechanism may be a lock mechanism having a structure other than the locking unit 33 and the lock-catch unit 23 described above, as long as the cover portion 3 is detachably attached to the main body portion 2.

The packing member 4 is a water stop member that performs water stop between the main body portion 2 and the cover portion 3, and is formed of resin, for example. The packing member 4 is formed of a material lower in rigidity than the cover portion 3, and is formed of an elastic resin such as elastomer, for example. The packing member 4 is provided along the lower part of the hanging portion 32 of the cover portion 3, and is formed in a rectangular ring shape in accordance with the shape of the lower part of the hanging portion 32. The packing member 4 is provided by two-color molding, for example. That is, the packing member 4 is formed by two-color molding together with the cover portion 3. Specifically, after the cover portion 3 is formed by a certain resin, the packing member 4 is formed by using a different type of resin.

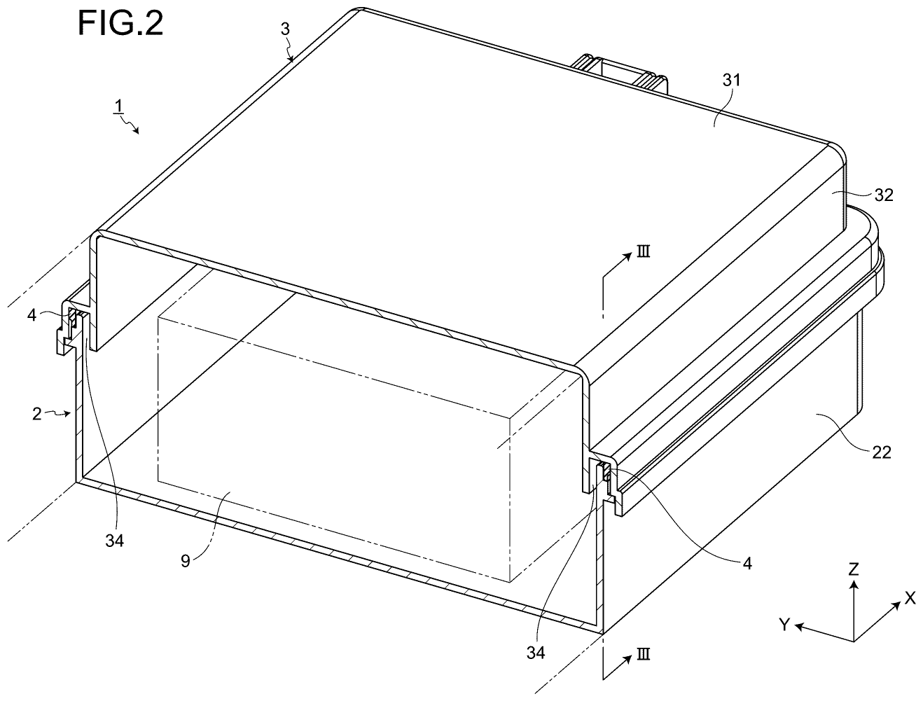

As illustrated in FIG. 2, the packing member 4 is provided on the cover portion 3 so as to be disposed between the main body portion 2 and the cover portion 3, and functions as a water stop between the main body portion 2 and the cover portion 3. FIG. 2 is a perspective view of the container box 1 in a state where substantially a half of the container box 1 is cut out. The packing member 4 is provided in a groove 34 formed in a lower part of the hanging portion 32 of the cover portion 3, for example. The groove 34 forms a space opening downward, and is continuously formed in the depth direction X and the width direction Y along the lower part of the hanging portion 32. The side wall 22 of the main body portion 2 is inserted into the groove 34 from below when the main body portion 2 and the cover portion 3 are attached to each other. With the packing member 4 interposed between the side wall 22 and the inner surface of the groove 34, water stop is performed between the main body portion 2 and the cover portion 3.

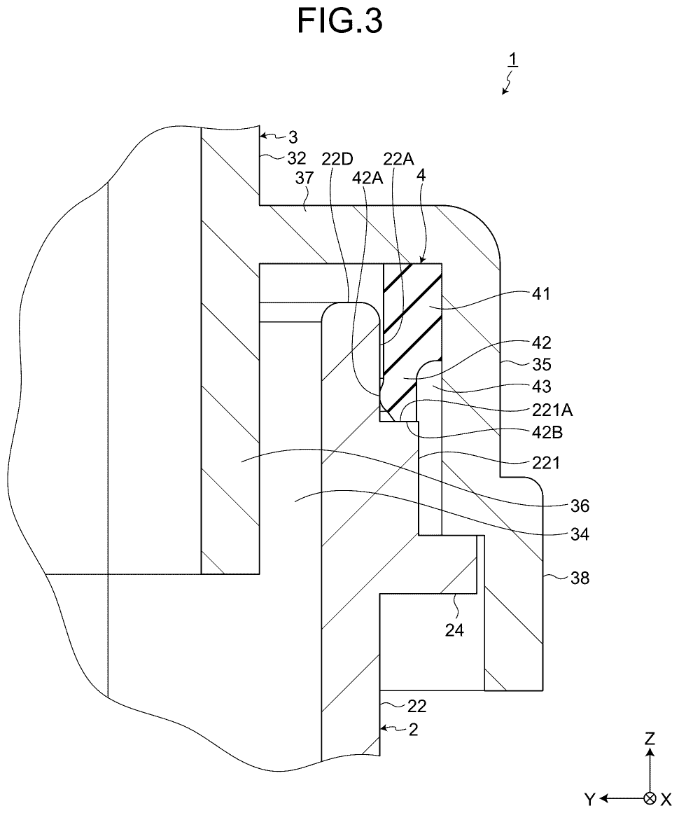

As illustrated in FIG. 3, the packing member 4 is provided in the groove 34 formed in the cover portion 3. FIG. 3 is an enlarged cross-sectional view of the container box 1, and illustrates a state in which the cover portion 3 is attached to the main body portion 2. The groove 34 is formed between an outer wall 35 and an inner wall 36, which are provided below the hanging portion 32. The hanging portion 32 branches into inner and outer portions at the lower part to form the inner wall 36 and the outer wall 35. The inner wall 36 is a wall portion formed at a lower part of the hanging portion 32. The outer wall 35 is a wall portion branching to the outer side via a protrusion 37, and is located outside the inner wall 36 and provided side by side with the inner wall 36 at a predetermined distance from the inner wall 36. The protrusion 37 is provided so as to protrude outward from a lower part of the hanging portion 32, and has the outer wall 35 hanging from a distal end of the protrusion 37. The outer wall 35 has an extension 38 continuously formed from the lower part of the outer wall 35. The extension 38 is a wall portion that covers the outer side of the side wall 22 of the main body portion 2. The groove 34 is formed so as to be surrounded by the inner wall 36, the protrusion 37, and the outer wall 35, and is a space opening downward. The groove 34 is formed in an extending direction (the depth direction X in FIG. 3) of the lower part of the hanging portion 32.

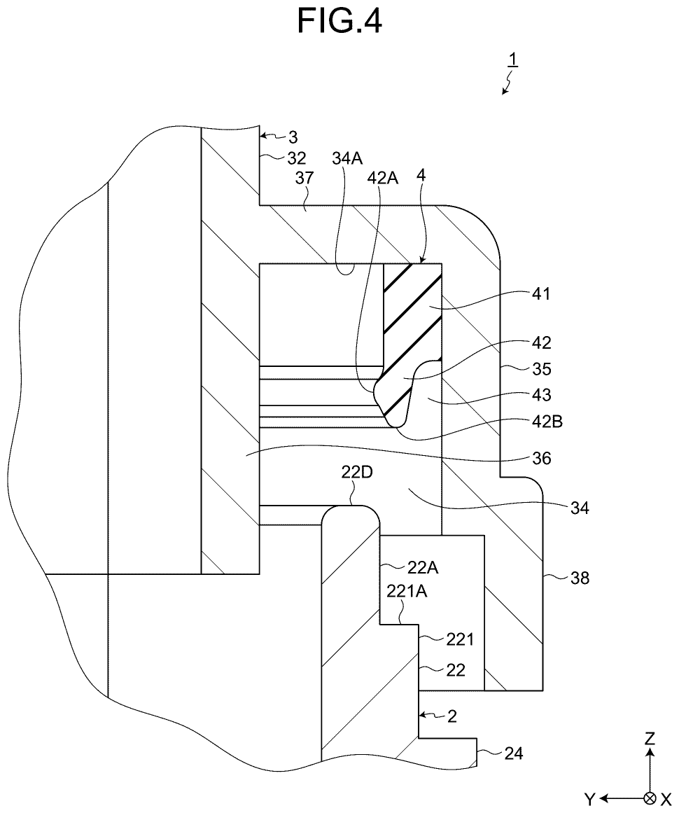

As illustrated in FIG. 4, the packing member 4 is attached to an inner surface 34A of the groove 34. FIG. 4 is an enlarged cross-sectional view of the container box 1, illustrating a state where the main body portion 2 and the cover portion 3 are separated from each other. The packing member 4 includes a packing body 41 and a seal portion 42, with the packing body 41 attached to the inner surface 34A of the groove 34. The packing body 41 is formed in a rectangular parallelepiped having a rectangular cross section, for example, and is attached to the inner surface 34A on the inner side of the outer wall 35 and the inner side of the protrusion 37. The seal portion 42 protrudes obliquely from the packing body 41 with respect to the attachment direction Z of the cover portion 3, and comes into contact with the side wall 22 of the main body portion 2 to perform water stop. That is, the seal portion 42 obliquely protrudes toward the side where the side wall 22 is located with respect to the attachment direction Z of the cover portion 3 in a state where the cover portion 3 is not attached to the main body portion 2, and comes into contact with the side wall 22 of the main body portion 2 in a state where the cover portion 3 is attached to the main body portion 2 to perform water stop between the main body portion 2 and the cover portion 3. The packing member 4 brings the seal portion 42 into contact with the side portion of the side wall 22 to achieve water stop, rather than being abut against an upper end surface 22D of the side wall 22 for water stop. This makes it possible for the container box 1 to easily attach the cover portion 3 with no strong force required in attaching the cover portion 3 to the main body portion 2.

There is a void portion 43 formed in the packing member 4. The void portion 43 is a space for allowing bending of the seal portion 42 to the side opposite to the side wall 22, and is formed on the side opposite to the side wall 22 with respect to the seal portion 42. Since the void portion 43 is formed on the side opposite the protruding side of the seal portion 42, the seal portion 42 can be bent toward the void portion 43 even when the seal portion 42 has an undercut shape. This makes it possible to mold the packing member 4.

In FIGS. 3 and 4, the seal portion 42 includes a first lip 42A and a second lip 42B. The first lip 42A and the second lip 42B, being portions that come into contact with the main body portion 2 to perform water stop, are formed at distal ends of the seal portion 42. The first lip 42A is a water-stop lip protruding toward a side surface 22A of the side wall 22 of the main body portion 2, and comes in contact with the side surface 22A of the side wall 22 to perform water stop. That is, the first lip 42A comes into contact with the side surface 22A of the side wall 22 in a state where the cover portion 3 is attached to the main body portion 2 to perform water stop between the main body portion 2 and the cover portion 3. The seal portion 42 is bent toward the void portion 43 by the contact of the first lip 42A to the side surface 22A in a state where the cover portion 3 is attached to the main body portion 2. Examples of the protruding shape of the first lip 42A include a semicircular shape in cross section or a dome shape in cross section. The side surface 22A of the side wall 22 is a surface of the side wall 22 and formed along the attachment direction Z.

The second lip 42B is a water-stop lip protruding toward an upper surface 221A of a shelf portion 221 of the side wall 22 in a semicircular shape or a dome shape in cross section, and comes in contact with the upper surface 221A of the shelf portion 221 to perform water stop. The shelf portion 221 is a portion protruding from the side surface 22A of the side wall 22, and includes the upper surface 221A formed in a direction intersecting the side surface 22A. That is, the shelf portion 221 protrudes in a thickness direction (in FIG. 4, the width direction Y) of the side wall 22 at the upper part of the side wall 22, and forms the upper surface 221A like a shelf by partially increasing the thickness at the side wall 22. The second lip 42B is provided so as to protrude toward the shelf portion 221 of the side wall 22 in a state where the cover portion 3 is attached to the main body portion 2, and comes in contact with the upper surface 221A of the shelf portion 221 to perform water stop between the main body portion 2 and the cover portion 3. Examples of the protruding shape of the second lip 42B include a semicircular shape in cross section or a dome shape in cross section. The seal portion 42 includes the first lip 42A and the second lip 42B to form a two-stage lip, enhancing the water-stop performance between the main body portion 2 and the cover portion 3.

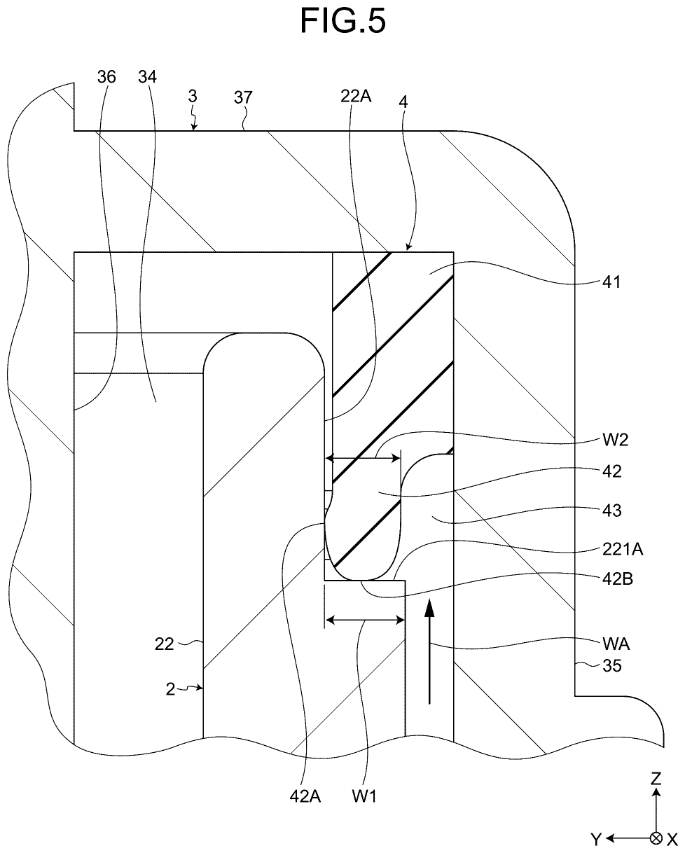

As illustrated in FIG. 5, the shelf portion 221 is provided such that a protruding length is a width of the seal portion 42 or more. That is, the shelf portion 221 is provided such that a width W1 of the upper surface 221A in the protruding direction (in FIG. 5, the width direction Y) is a width W2 of the seal portion 42 or more. Therefore, in a state where the cover portion 3 is attached to the main body portion 2, the seal portion 42 is accommodated within the width W1 of the shelf portion 221 and comes into contact with the side wall 22. This enhances the water-stop performance of the packing member 4.

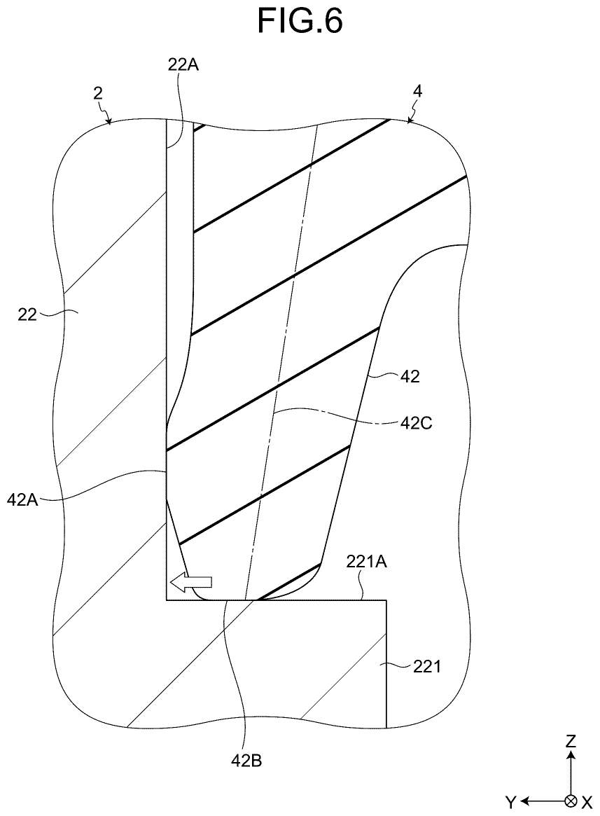

As illustrated in FIG. 6, the seal portion 42 is provided to allow the second lip 42B to fall toward the side surface 22A in a state where the cover portion 3 is attached to the main body portion 2. For example, the second lip 42B is formed at a center position 42C of the seal width, forming the seal portion 42 obliquely toward the side surface 22A. With this configuration, when the second lip 42B comes in contact with the upper surface 221A, the second lip 42B falls toward the side surface 22A.

In FIG. 3, on a lower side of the shelf portion 221 of the side wall 22, a protruding piece 24 is formed. The protruding piece 24 is a portion protruding from the side wall 22, and comes in contact with the hanging portion 32 of the cover portion 3 to regulate the downward movement of the cover portion 3. The protruding piece 24 is formed at a position on the upper part of the side wall 22, continuously with the entire circumference of the four side walls 22, for example. The protruding piece 24 is provided so as to come in contact with the lower end of the outer wall 35. In this manner, the protruding piece 24 comes in contact with the outer wall 35 to close the groove 34 by the protruding piece 24, suppressing intrusion of water or the like into the groove 34 from the outside.

Next, the water-stop performance in the container box 1 according to the present embodiment will be described.

As illustrated in FIG. 4, in a state where the cover portion 3 is separated from the main body portion 2, the upper part of the side wall 22 of the main body portion 2 is inserted into the groove 34 of the cover portion 3, thereby attaching the cover portion 3 to the main body portion 2. That is, the cover portion 3 is disposed corresponding to the opening 21 of the main body portion 2, allowing the cover portion 3 to cover the opening 21. Subsequently, the locking unit 33 of the cover portion 3 and the lock-catch unit 23 of the main body portion 2 are engaged with each other, allowing the cover portion 3 to be attached to the main body portion 2.

In this state, as illustrated in FIG. 3, the packing member 4 provided in the groove 34 is disposed between the main body portion 2 and the cover portion 3, so as to suppress intrusion of water between the main body portion 2 and the cover portion 3 to achieve water stop. At this time, the seal portion 42 of the packing member 4 is pressed against the side wall 22. That is, the first lip 42A of the seal portion 42 is pressed against the side surface 22A, while the second lip 42B is pressed against the upper surface 221A of the shelf portion 221. That is, the seal portion 42 constitutes a two-stage lip and exhibits high water-stop performance.

As illustrated in FIG. 6, when the cover portion 3 is attached to the main body portion 2 and the distal end of the seal portion 42 comes in contact with the upper surface 221A of the shelf portion 221, the seal portion 42 is installed to allow the second lip 42B at the distal end of the seal portion 42 to fall toward the side surface 22A. This allows the first lip 42A to be firmly pressed against the side surface 22A, making it possible to enhance the water-stop performance of the seal portion 42.

Furthermore, as illustrated in FIG. 5, the shelf portion 221 is formed on the side wall 22, achieving a structure to suppress occurrence of direct splash of water onto the first lip 42A and the second lip 42B. That is, even when water WA intrudes into the groove 34 from the outside of the container box 1, the water WA enters the void portion 43 and thus, direct intrusion of the water WA into the first lip 42A and the second lip 42B will be suppressed. At this time, the water WA acts to allow the side surface 22A to press the seal portion 42 from the void portion 43 side, enhancing the water-stop performance of the seal portion 42. Consequently, the packing member 4 can suppress intrusion of the water WA between the first lip 42A/the second lip 42B and the side wall 22. In this manner, the container box 1 is excellent in water-stop performance between the main body portion 2 and the cover portion 3, and can ensure a water-stop function.

Next, moldability in the container box 1 according to the present embodiment will be described.

In FIG. 1, the packing member 4 is manufactured by resin molding. For example, the packing member 4 is manufactured by two-color molding together with the cover portion 3. In this case, the cover portion 3 and the packing member 4 are molded using two different types of resin. That is, after the cover portion 3 is molded by resin and the cover portion 3 is cooled, the packing member 4 is molded by resin. When the packing member 4 is cooled, a mold is opened (demolding), and the cover portion 3 and the packing member 4 are taken out from the mold as an integrated molded product.

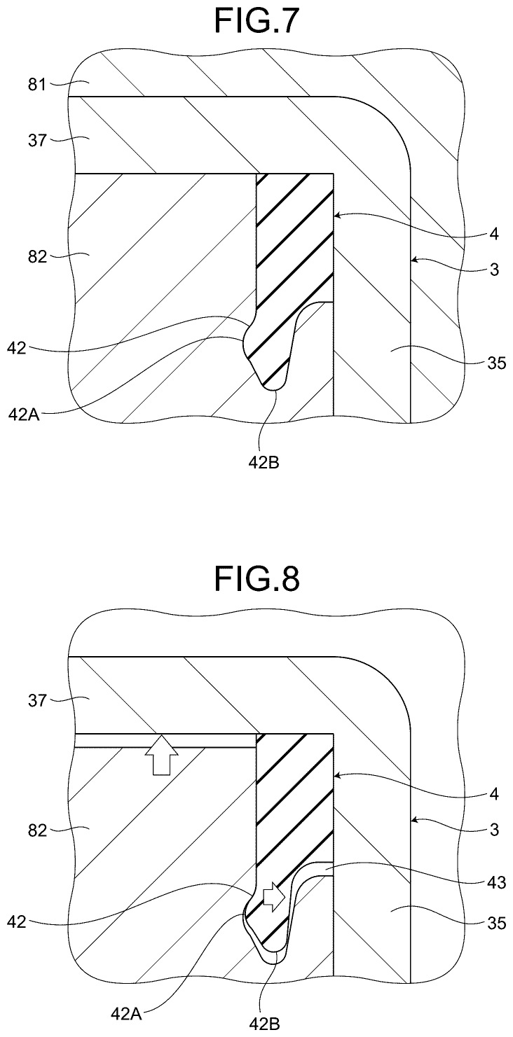

FIG. 7 illustrates a state after the cover portion 3 and the packing member 4 have been molded, cooled, and solidified, being a state immediately before demolding. The cover portion 3 and the packing member 4 have been molded between a mold 81 and a mold 82. For example, the mold 81 is a fixed mold, and the mold 82 is a movable mold. The moving direction of the mold 82 is the downward direction in FIG. 7. With respect to the mold 81 as a fixed mold, the mold 82 being a movable mold, the cover portion 3, and the packing member 4 are moved and separated from the mold 81.

Subsequently, as illustrated in FIG. 8, the cover portion 3 and the packing member 4 in close contact with the mold 82 are removed from the mold 82. For example, the cover portion 3 and the packing member 4 are separated from the mold 82 by operation of a detaching member such as an ejection pin. At this time, since the seal portion 42 of the packing member 4 protrudes obliquely with respect to the removing direction (upper direction in FIG. 8), an undercut occurs. However, in the packing member 4, the void portion 43 is formed behind the seal portion 42. Therefore, when removing the cover portion 3 and the packing member 4, the seal portion 42 deforms to be bent toward the void portion 43, suppressing application of a strong compressive force to the seal portion 42.

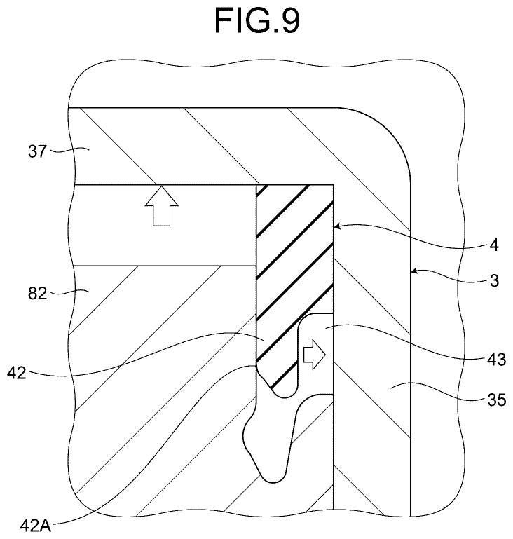

Subsequently, when the cover portion 3 and the packing member 4 are further separated from the mold 82 as illustrated in FIG. 9, the seal portion 42 of the packing member 4 is bent toward the void portion 43 and elastically deformed, making it possible to smoothly remove the cover portion 3 and the packing member 4 from the mold 82 without difficulty. This makes it possible to perform resin molding of the cover portion 3 and the packing member 4 while suppressing damage and plastic deformation of the packing member 4. Consequently, the container box 1 according to the present embodiment can achieve satisfactory molding of the cover portion 3 and the packing member 4.

As described above, the container box 1 of the present embodiment includes the packing member 4 in which the seal portion 42 and the void portion 43 are formed, and can allow the seal portion 42 to come into contact with the side wall 22 of the main body portion 2 to ensure the water-stop function, and can allow bending of the seal portion 42 by the void portion 43, leading to achievement of satisfactory molding of the packing member 4.

In addition, the container box 1 according to the present embodiment has the packing member 4 including the first lip 42A and the second lip 42B coming in contact with the side wall 22, making it possible to construct a two-stage seal by the first lip 42A and the second lip 42B, leading to enhancement of the water-stop performance between the main body portion 2 and the cover portion 3.

In addition, in the container box 1 according to the present embodiment, the width W1 of the upper surface 221A of the shelf portion 221 provided on the side wall 22 of the main body portion 2 is set to be the width W2 of the seal portion 42 or more. With this configuration, even when water intrudes into the position of the packing member 4, it is possible to suppress occurrence of direct splash of water onto the seal portion 42. This suppresses occurrence of roll-up of the seal portion 42 by the intruding water, making it possible to ensure the water-stop function.

While the container box 1 according to the embodiment has been described above, the container box according to the present invention is not limited to the above-described embodiment, and various modifications can be made within the scope described in the claims. The container box 1 according to the present embodiment may be configured by appropriately combining the components of the above-described embodiment and modifications.

For example, although the above embodiment has described the case where the first lip 42A and the second lip 42B are formed in the seal portion 42 of the packing member 4, it is also allowable to form only the first lip 42A in the seal portion 42. As another case, it is also allowable to form another lip other than the first lip 42A and the second lip 42B on the seal portion 42 and bring the another lip into contact with the side surface 22A of the side wall 22 or the upper surface 221A of the shelf portion 221. Even in these cases, similarly to the above-described embodiment, by using a configuration in which the seal portion 42 is brought into contact with the side wall 22 of the main body portion 2 to ensure the water-stop function, and the bending of the seal portion 42 is allowed by the void portion 43, it is also possible to achieve satisfactory molding of the packing member 4.

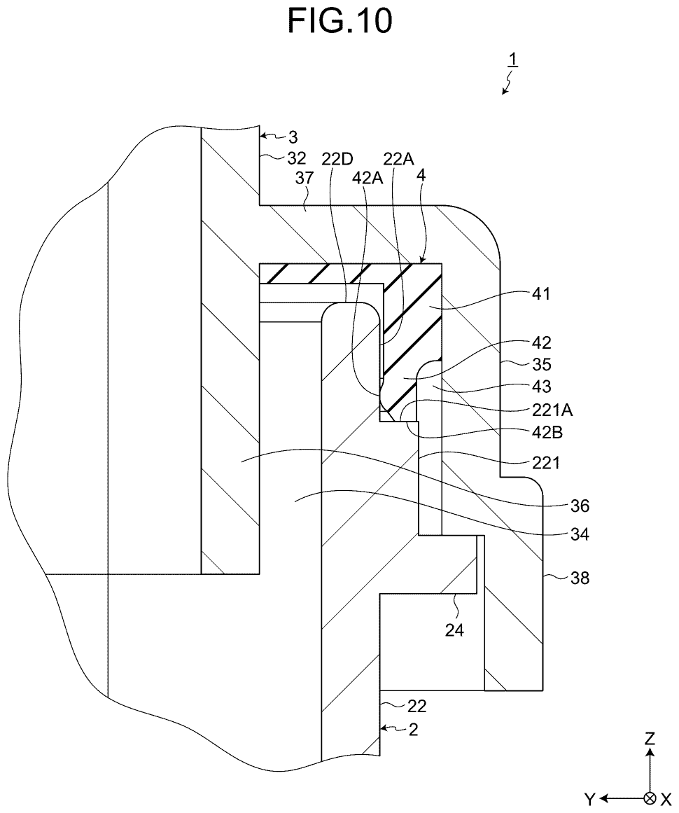

Although the above embodiment has described the case of using the cover portion 3 and the packing member 4 formed by two-color molding, it is also allowable to provide a container box in which the cover portion 3 and the packing member 4 are individually manufactured and then the packing member 4 is attached to the cover portion 3. For example, as illustrated in FIG. 10, the packing member 4 may have a configuration in which, for example, the packing body 41 has an L-shaped cross section and can be fitted to the upper part of the groove 34. The packing member 4 can be, for example, a member manufactured by molding a material such as resin and rubber. Even with such a container box 1, similarly to the above-described embodiment, by using a configuration in which the seal portion 42 is brought into contact with the side wall 22 of the main body portion 2 to ensure water-stop performance, and the bending of the seal portion 42 is allowed by the void portion 43, it is also possible to achieve satisfactory molding of the packing member 4.

Although the above embodiment has described the case where the container box 1 is applied to the electrical connection box that is mounted on a vehicle and accommodates the electronic component 9, the container box according to the present invention may also be applied to a container box that is not mounted on a vehicle. In addition, the container box according to the present invention may be applied to a container box that accommodates an accommodation object other than the electronic component 9.

According to the container box of the present embodiment, the packing member can be satisfactorily molded while ensuring the water-stop function by the packing member.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A container box comprising:
a main body portion that is capable of internally accommodating an accommodation object and has an opening that allows communication between an inside and an outside of the main body portion;
a cover portion attached to the main body portion so as to cover the opening; and
a packing member provided in the cover portion and configured to perform water stop between the main body portion and the cover portion,
wherein the main body portion includes a side wall formed along an attachment direction of the cover portion with respect to the main body portion and surrounding the inside,
the packing member forms a packing body attached to the cover portion, a seal portion protruding from the packing body and coming in contact with the side wall, and a void portion formed on an opposite side being a side opposite to the side wall with respect to the seal portion and allowing bending of the seal portion toward the opposite side, and
the seal portion protrudes obliquely toward a side on which the side wall is located with respect to the attachment direction of the cover portion and the main body portion side in a state where the cover portion is not attached to the main body portion, and the seal portion includes a first lip being formed at a distal end of the seal portion and coming in contact with a side surface of the side wall in a state where the cover portion is attached to the main body portion.

2. The container box according to claim 1,
wherein the main body portion forms a shelf portion having an upper surface protruding from the side surface and formed in a direction intersecting the side surface, and
the seal portion includes a second lip formed at a distal end of the seal portion and coming into contact with the upper surface of the shelf portion in a state where the cover portion is attached to the main body portion.

3. The container box according to claim 2,
wherein the shelf portion is provided such that a width of the upper surface in a protruding direction is a width of the seal portion or more.
